(19) United States
(12) Patent Application Publication
(10) Pub. No.: US 2025/0379239 A1
(43) Pub. Date: Dec. 11, 2025

(54) PROCESS FOR THE DEPOSITION OF RUTHENIUM NANOSTRUCTURES OVER COBALT OXIDE INCORPORATED NITROGEN-DOPED CARBON

(71) Applicants: Muhammad Arif Nadeem, Islamabad (PK); Mohammed Ali Assiri, Abha (SA); Fatima Nasim, Islamabad (PK); Tarik E. Ali, Abha (SA); Muhammad Imran, Abha (SA)

(72) Inventors: Muhammad Arif Nadeem, Islamabad (PK); Mohammed Ali Assiri, Abha (SA); Fatima Nasim, Islamabad (PK); Tarik E. Ali, Abha (SA); Muhammad Imran, Abha (SA)

(21) Appl. No.: 18/735,306

(22) Filed: Jun. 6, 2024

(51) Int. Cl. H01M 4/92; H01M 8/083

(52) U.S. Cl. CPC H01M 4/926; H01M 8/083

(57) ABSTRACT

A method of forming ruthenium nanoparticles over cobalt oxide encapsulated nitrogen rich carbon nanotubes (Ru@CoOx/N-CNTs) from ZIF-12. The method includes mixing 510 a first solution of cobalt nitrate hexahydrate, a benzimidazole solution, and N, N-dimethyl formamide. The first solution is transferred 520 to a Teflon lined autoclave and heated at 150° C. The first solution is allowed to cool 530. The first solution is filtered 540 and dried 550 in an oven to produce a first composition. The method includes calcinating 560 the first composition at 850° C. to obtain the cobalt oxide encapsulated nitrogen rich carbon nanotubes (CoOx/N-CNTs). The method includes coating 570 the CoOx/N-CNTs with ruthenium to obtain Ru@CoOx/N-CNTs and dispersing 580 the Ru@CoOx/N-CNTs in a Nafion+ isopropanol mixture. The electrochemical activity of Ru@CoOx/N-CNTs towards oxygen reduction reaction is measured.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of fuel cell chemistry, and more specifically to a methods of forming Ruthenium nanoparticles supported over Cobalt oxides encapsulated nitrogen rich carbon nanotubes, from ZIF-12 using solid state reaction strategy for use as an efficient and durable catalyst with minimal amount of noble metal loading used.

### 2) Description of Related Art

An emerging class of materials with varying cavities and dimensions is metal organic frameworks. Metal organic framework also known as coordination polymers consists of inorganic nodes acting as secondary building unit and organic linkers. The functionalization of organic linkers gives MOFs rich and diverse functional properties. Zeolite imidazole frameworks is the subclass of porous materials known as metal organic frameworks. The porous nature of ZIFs can be used for a variety of applications such as gas storage, catalysis etc. Depending upon the nature of organic linker, the cavity size of porous coordination polymers varies considerably.

Porous coordination polymers have attracted large attention of the scientists during the last 2 decades due to the reason of aesthetically interesting structures that are of great interest for applications in a variety of fields related to porous materials. These are the areas of storage, separation, and catalysis, which are based on the pore size and shape as well as the host guest interactions involved. In addition, biomedical applications of porous coordination polymers, the use of these materials as sensors are currently investigated.

The current global energy crisis, depletion of non-renewable energy sources and environmental pollution stimulates the development of alternative, renewable energy source to traditional fossil fuels with little or no emission of toxic gases. Fuel cells are attracting the attention of scientific community world-wide due to its high conversion efficiency and environment friendly nature as a substitute to conventional fuel sources.

Due to the porous natures, it would be desirable to use ZIF-12 as an electrocatalyst in green energy technologies i.e., fuel cells to circumvent the energy crisis and pollution.

### BRIEF SUMMARY OF THE INVENTION

In Chemistry, this process relates to the methods of forming cobalt oxide encapsulated nitrogen rich carbon nanotubes, from ZIF-12 via solid state reaction strategy and then deposition of Ruthenium nanoparticles over it. The disclosed method paves a way for the design of efficient and durable catalysts with minimal amount of noble metal loading to be employed in sustainable technologies.

The instant invention in one form is directed to a method of forming ruthenium decorated cobalt oxide encapsulated nitrogen rich carbon nanotubes (Ru@CoOx/N-CNTs) from Zeolite imidazole framework (ZIF-12) is a solid-state reaction for forming carbon nanotubes from ZIF-12. The method includes first dissolving cobalt nitrate hexahydrate (Co (NO3)2·6H2O and benzimidazole in N, N-dimethylformamide and heating in oven at 150° C. to produce an ultrafine crystalline material, and then reacting the ultrafine material in a chemical vapor deposition reactor under inert atmosphere to form the cobalt oxide encapsulated nitrogen carbon nanotubes (CoOx/N-CNTs). The prepared cobalt oxide encapsulated carbon nanotubes were then decorated with ruthenium nanoparticles to synthesize (Ru@CoOx/N-CNTs). The method provides for total conversion of the ZIF-12 to cobalt oxide encapsulated nitrogen doped carbon nanotubes (CoOx/N-CNTs) having a variety of differing diameters and lengths, including multiwalled carbon nanotubes with a high degree of wall graphitization.

Thus, the method is suitable for large scale production of ruthenium nanoparticles supported over cobalt oxide embedded nitrogen rich carbon nanotubes for electrocatalytic oxygen reduction reaction in fuel cells. The minimal of ruthenium has shown outstanding results during oxygen reduction reaction. This will minimize the cost as well as increase the commercialization of fuel cell technology. These and other features of the present invention will become readily apparent upon further review of the following specifications and drawings.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a schematic representation for the synthesis of the materials and its application in fuel cell;

FIGS. 2A and 2B show the HRTEM and high angle annular dark field transmission electron microscope analysis of CoOx/N-CNTs and Ru@CoOx/N-CNTs respectively show the total conversion of ZIF-12 to nitrogen rich carbon nanotubes with varying diameters and length;

FIG. 3 shows the X-ray diffractogram of CoOx/N-CNTs and Ru@CoOx/N-CNTs which confirms the formation of graphitic carbon in both samples;

FIGS. 4A, 4B, 4C and 4D show the electrocatalytic activity of Ru@CoOx/N-CNTs in O₂ saturated 0.1 M potassium hydroxide (KOH) acting as electrolyte and its comparison with 20 wt % Pt/C (a benchmark catalyst for oxygen reduction reaction); and

FIG. 5 shows a flowchart 500 for a method of forming ruthenium nanoparticles over cobalt oxide encapsulated nitrogen rich carbon nanotubes (Ru@CoOx/N-CNTs) from ZIF-12.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Ligand as used herein refers to a group, ion, or molecule coordinated to a central atom or molecule in a complex.

As this invention is susceptible to embodiments of many different forms, it is intended that the present disclosure be considered as an example of the principles of the invention and not intended to limit the invention to the specific embodiments shown and described.

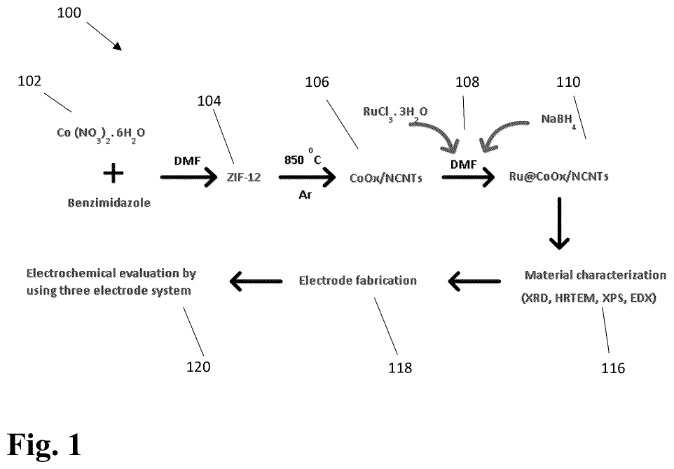

Referring now to FIG. 1, for the synthesis of ruthenium nanoparticles decorated over cobalt oxide encapsulated nitrogen rich carbon nanotubes (Ru@CoOx/N-CNTs), cobalt nitrate hexahydrate and benzimidazole were dissolved in N, N-dimethyl formamide (DMF). The solution is transferred to Teflon lined stainless steel autoclave and kept in an oven at 150° C. for 2 days. The product is filtered, washed, and dried in an oven at 70° C. The dried product is then transferred to alumina boat and kept in tube furnace at 850° C. for 8 hours. The as-prepared product (CoOx/N-CNTs) can then be evaluated for electrochemical testing. The CoOx/N-CNTs is then decorated with ruthenium nanoparticles by using sodium borohydride as a reducing agent. Solid state reaction is a common chemical laboratory technique used to obtain solid materials with high performance and high purity. The obtained material (Ru@CoOx/N-CNTs) is characterized and evaluated as an electrode material for oxygen reduction reaction. For calcination a tube furnace with a diameter of 3.8 cm may be used. Argon gas used in the tuber furnace provides an inert atmosphere in the tube furnace.

The electrochemical activity may be evaluated by using three electrode assembly setups in which Hg/HgO is used as reference electrode, graphite rod as a counter and a rotating disk electrode (RDE) as a working electrode. The working electrode may be prepared by dispersing 2 mg of synthesized material in 90 μL isopropanol and 10 μL Nafion for 2 hours. The resulting homogenous slurry is drop casted on the rotating disk electrode (RDE). The coated RDE is dried and used as working electrode for the evaluation of oxygen reduction activity using Gamry RDE710 rotating electrode instrument. Cyclic voltammetry and linear sweep voltammetry curves are recorded to measure the electrocatalytic performance of the synthesized material (Ru@CoOx/N-CNTs) towards oxygen reduction reaction in Ar and O₂ saturated 0.1 M KOH.

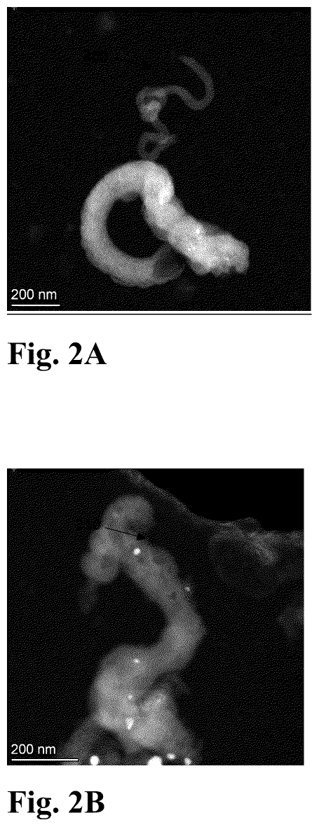

A dark black colored product with a significant increase in volume is obtained upon calcination. FIGS. 2A and 2B show the HRTEM and high angle annular dark field transmission electron microscope analysis of CoOx/N-CNTs and Ru@CoOx/N-CNTs respectively show the total conversion of ZIF-12 to nitrogen rich carbon nanotubes with varying diameters and length.

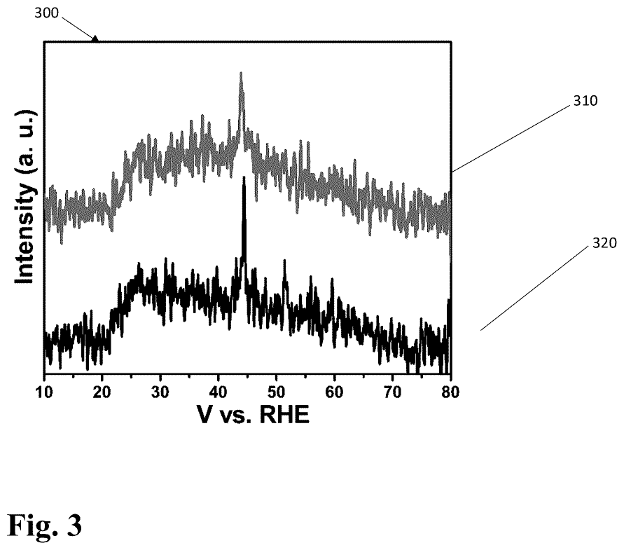

FIG. 3 shows the X-ray diffractogram of CoOx/N-CNTs and Ru@CoOx/N-CNTs which confirms the formation of graphitic carbon in both samples. The integrity of carbon nanotube is retained after the deposition of ruthenium nanoparticles.

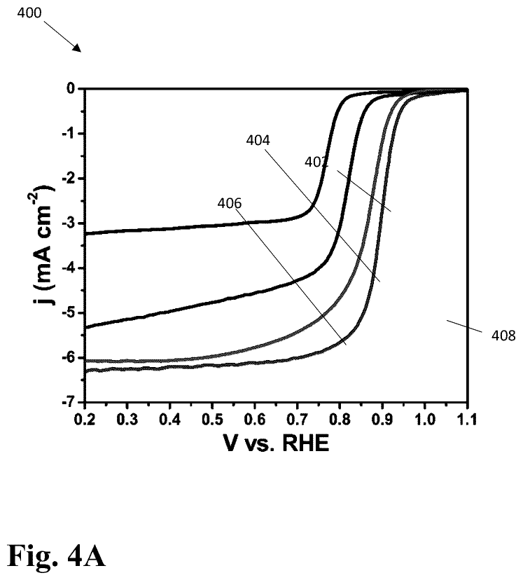

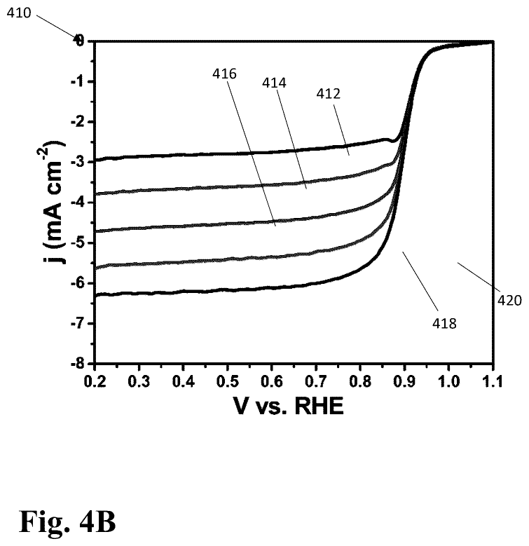

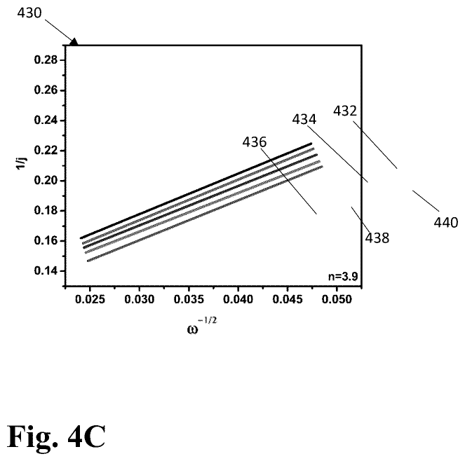

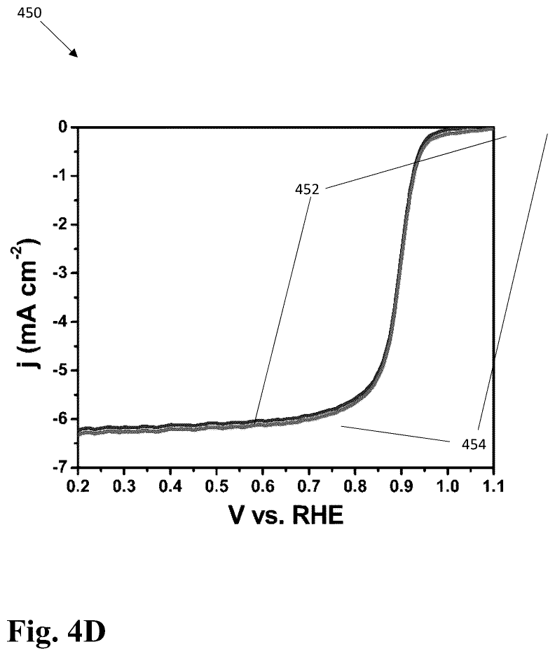

FIGS. 4A, 4B, 4C and 4D show the electrocatalytic activity of Ru@CoOx/N-CNTs in O₂ saturated 0.1 M potassium hydroxide acting as electrolyte (KOH) and its comparison with 20 wt % Pt/C (a benchmark catalyst for oxygen reduction reaction). The synthesized material has comparable activity with Pt/C towards O₂ reduction. The catalyst exhibited enhanced durability over 10,000 cycles.

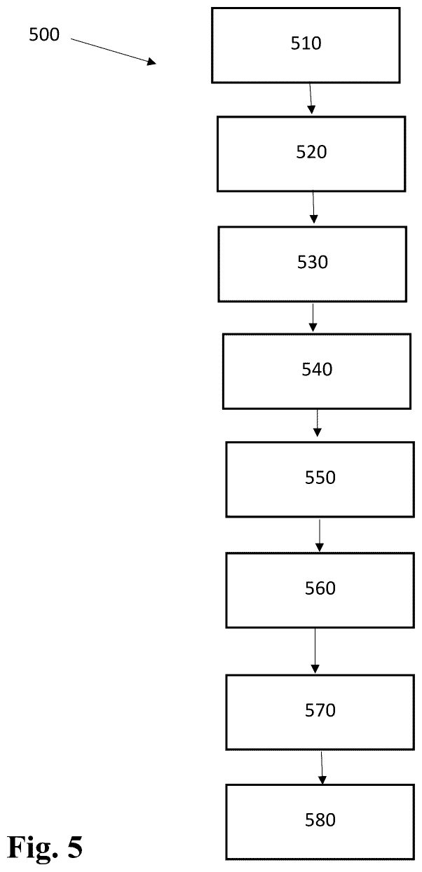

FIG. 5 shows a flowchart 500 for a method of forming ruthenium nanoparticles over cobalt oxide encapsulated nitrogen rich carbon nanotubes (Ru@CoOx/N-CNTs) from ZIF-12. The method includes mixing 510 a first solution of cobalt nitrate hexahydrate, a benzimidazole solution, and N, N-dimethyl formamide. The first solution is transferred 520 to a Teflon lined autoclave and heated at 150° C. The first solution is allowed to cool 530. The first solution is filtered 540 and dried 550 in an oven to produce a first composition. The method includes calcinating 560 the first composition at 850° C. to obtain the cobalt oxide encapsulated nitrogen rich carbon nanotubes (CoOx/N-CNTs). The method includes coating 570 the CoOx/N-CNTs with ruthenium to obtain Ru@CoOx/N-CNTs and dispersing 580 the Ru@CoOx/N-CNTs in a Nafion+ isopropanol mixture. The electrochemical activity of Ru@CoOx/N-CNTs towards oxygen reduction reaction is measured.

The step of mixing the cobalt nitrate hexahydrate solution may include the dissolution of 0.167 mM of Co(NO₃)₂·6H₂O and 6.09 mM of benzimidazole in N, N-dimethyl formamide. The step of transferring the solution to a Teflon lined autoclave may include transfer of salt and a ligand solution to the Teflon lined stainless steel autoclave and heating the autoclave to 150° C. for 2 days. The step of filtering and drying the product may include filtering the crystalline material and drying at 70° C. in an oven. The step of calcination may include placing the dried product in alumina boat in a quartz tube and heating the quartz tube to 850° C. at a heating rate of 5° C./min under Ar atmosphere to obtain CoOx/N-CNTs. The step of deposition of ruthenium nanoparticles may include use of sodium borohydride as a reducing agent to obtain Ru@CoOx/N-CNTs. The step of dispersing the Ru@CoOx/N-CNTs may include the use of isopropanol and 5% Nafion mixture (100 μL) in a sonicator with a 100 watts power output at about 42 kHz of frequency.

The method as shown in FIG. 5 provides a ruthenium catalyst of ruthenium nanoparticles over cobalt oxide encapsulated nitrogen rich carbon nanotubes (Ru@CoOx/N-CNTs) from ZIF-12, the ruthenium catalyst. The ruthenium catalyst includes a first solution including cobalt nitrate hexahydrate, a benzimidazole solution, and N, N-dimethyl formamide wherein the first solution is transferred to a Teflon lined autoclave and heating at 150° C. and allowed to cool. The ruthenium catalyst includes a first composition which is the first solution filtered and dried in an oven and calcinated at 850° C. to obtain the cobalt oxide encapsulated nitrogen rich carbon nanotubes (CoOx/N-CNTs). The CoOx/N-CNTs is coated with ruthenium to obtain Ru@CoOx/N-CNTs and the Ru@CoOx/N-CNTs dispersed in a Nafion+ isopropanol mixture.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of forming ruthenium nanoparticles over cobalt oxide encapsulated nitrogen rich carbon nanotubes (Ru@CoOx/N-CNTs) from ZIF-12, the method comprising the steps of: mixing a first solution of cobalt nitrate hexahydrate, a benzimidazole solution, and N, N-dimethyl formamide; transferring the first solution to a Teflon lined autoclave and heating at 150° C.; allowing the first solution to cool; filtering the first solution; drying the first solution in an oven to produce a first composition; calcinating the first composition at 850° C. to obtain the cobalt oxide encapsulated nitrogen rich carbon nanotubes (CoOx/N-CNTs); coating the CoOx/N-CNTs with ruthenium to obtain Ru@CoOx/N-CNTs; and dispersing the Ru@CoOx/N-CNTs in a Nafion+ isopropanol mixture.

2. The method according to claim 1 including measuring the electrochemical activity of Ru@CoOx/N-CNTs towards oxygen reduction reaction after dispersing the Ru@CoOx/N-CNTs in a Nafion+ isopropanol mixture.

3. The method according to claim 1 wherein the step of mixing the cobalt nitrate hexahydrate solution includes the dissolution of 0.167 mM of Co(NO₃)₂·6H₂O and 6.09 mM of benzimidazole in N, N-dimethyl formamide.

4. The method according to claim 1 wherein the step of transferring the solution to a Teflon lined autoclave includes transfer of salt and a ligand solution to the Teflon lined stainless steel autoclave and heating the autoclave to 150° C. for 2 days.

5. The method according to claim 1 wherein the step of filtering and drying the product includes filtering the crystalline material and drying at 70° C. in an oven.

6. The method according to claim 1 wherein the step of calcination includes the placing the dried product in alumina boat in a quartz tube and heating the quartz tube to 850° C. at a heating rate of 5° C./min under Ar atmosphere to obtain CoOx/N-CNTs.

7. The method according to claim 1 wherein the step of deposition of ruthenium nanoparticles includes use of sodium borohydride as a reducing agent to obtain Ru@CoOx/N-CNTs.

8. The method according to claim 1 wherein the step of dispersing the Ru@CoOx/N-CNTs includes the use of isopropanol and 5% Nafion mixture (100 μL) in a sonicator with a 100 watts power output at about 42 kHz of frequency.

9. A ruthenium catalyst of ruthenium nanoparticles over cobalt oxide encapsulated nitrogen rich carbon nanotubes (Ru@CoOx/N-CNTs) from ZIF-12, the ruthenium catalyst comprising: a first solution including cobalt nitrate hexahydrate, a benzimidazole solution, and N, N-dimethyl formamide wherein the first solution is transferred to a Teflon lined autoclave and heating at 150° C. and allowed to cool; and a first composition including the first solution wherein the first solution has been filtered and dried in an oven and calcinated at 850° C. to obtain the cobalt oxide encapsulated nitrogen rich carbon nanotubes (CoOx/N-CNTs); wherein the CoOx/N-CNTs is coated with ruthenium to obtain Ru@CoOx/N-CNTs; and wherein the Ru@CoOx/N-CNTs dispersed in a Nafion+ isopropanol mixture.

10. The ruthenium catalyst according to claim 9 wherein mixing the cobalt nitrate hexahydrate solution includes the dissolution of 0.167 mM of Co(NO₃)₂·6H₂O and 6.09 mM of benzimidazole in N, N-dimethyl formamide.

11. The ruthenium catalyst according to claim 9 wherein transferring the solution to Teflon lined autoclave includes transfer of salt and a ligand solution to the Teflon lined stainless steel autoclave and heating the autoclave to 150° C. for 2 days.

12. The ruthenium catalyst according to claim 9 wherein filtering and drying the product includes filtering the crystalline material and drying at 70° C. in an oven.

13. The ruthenium catalyst according to claim 9 wherein calcination includes the placing the dried product in alumina boat in a quartz tube, heating the quartz tube to 850° C. at a heating rate of 5° C./min under Ar atmosphere to obtain CoOx/N-CNTs.

14. The ruthenium catalyst according to claim 9 wherein deposition of ruthenium nanoparticles includes use of sodium borohydride as a reducing agent to obtain Ru@CoOx/N-CNTs.

15. The ruthenium catalyst according to claim 9 wherein dispersing the Ru@CoOx/N-CNTs includes use of isopropanol and 5% Nafion mixture (100 μL) in a sonicator with a 100 watts power output at about 42 kHz of frequency.
